(19) United States
(12) Patent Application Publication
(10) Pub. No.: US 2013/0183494 A1
(43) Pub. Date: Jul. 18, 2013

(54) COMPONENT PROPERTIES THROUGH OPTIMIZED PROCESS MANAGEMENT IN LASER SINTERING

(71) Applicants: Maik GREBE, Bochum (DE); Sylvia Monsheimer, HALTERN AM SEE (DE); Wolfgang Diekmann, Waltrop (DE); Juergen Kreutz, Marl (DE)

(72) Inventors: Maik GREBE, Bochum (DE); Sylvia Monsheimer, HALTERN AM SEE (DE); Wolfgang Diekmann, Waltrop (DE); Juergen Kreutz, Marl (DE)

(73) Assignee: Evonik Degussa GmbH, Essen (DE)

(21) Appl. No.: 13/552,891

(22) Filed: Jul. 19, 2012

(30) Foreign Application Priority Data
Jul. 21, 2011 (DE) 10 2011 079 518.9

(51) Int. Cl. B29C 35/08; B32B 27/16

(52) U.S. Cl. CPC B29C 35/08; B32B 27/16
USPC 428/156; 264/497; 425/174.4

(57) ABSTRACT

A method for layer-by-layer production of a three dimensional object is provided. The method includes applying a layer of a polymer powder having a thickness; selectively irradiating portions of the polymer powder layer with a laser beam having an average power density and a focus maximum power density to melt and sinter the irradiated polymer powder; cooling the melted and sintered powder to obtain a solid mass having a shape; and repeating the application, irradiating and cooling operations until the three dimensional object is obtained; wherein a duty factor of the laser beam is greater than 60%. Also provided is an apparatus to carry out the method and a molding obtained therefrom.

### CROSS REFERENCE TO RELATED APPLICATIONS

This application claims priority to German Application No. 102011079518.9, filed Jul. 21, 2011, the disclosure of which is incorporated herein by reference in its entirety.

### BACKGROUND OF THE INVENTION

### Field of the Invention

The present invention relates to an apparatus for the layer-by-layer production of three-dimensional objects, to processes for layer-by-layer production, and also to corresponding mouldings.

A task frequently encountered in very recent times is the rapid production of prototypes. Processes which permit this are termed rapid prototyping/rapid manufacturing, or else additive fabrication processes. Processes that are particularly suitable are those which are based on pulverulent materials and in which the desired structures are produced layer-by-layer through selective melting and solidification. Supported structures for overhangs and undercuts can be omitted because the powder bed surrounding the molten regions provides sufficient supportive effect. The downstream operation of removing supports is also omitted. The processes are also suitable for small-run production. The construction-chamber temperature is selected in such a way that the structures produced layer-by-layer do not warp during the construction process.

A process which has particularly good suitability for the purpose of rapid prototyping/rapid manufacturing is selective laser sintering (SLS). The laser sintering (rapid prototyping) process for producing mouldings from pulverulent polymers is described in detail in U.S. Pat. No. 6,136,948 and WO 96/06881 (both DTM Corporation). A wide variety of polymers and copolymers is claimed for the application, examples being polyacetate, polyester, polyvinyl chloride, polypropylene, polyethylene, ionomers and polyamide.

A problem with the processes described above is that the polymeric material is damaged by power peaks of the laser. The increased temperatures caused by the power peaks can lead to molecular-weight degradation of the polymer. Damage caused by heat can cause discoloration of the components. The said temperature peaks moreover occasionally cause release of constituents of the polymeric materials during processing. The substances released disrupt the process because these deposit on important components such as lenses or pyrometers (radiation thermometers) and impair their function.

Development in the SLS sector is moving towards constantly higher irradiation rates, which require constantly increasing power of the laser in order to introduce the necessary laser energy into the powder material. A simple reduction of the power of the laser in order to avoid molecular-weight degradation is therefore not helpful in achieving the objective, as such measure would markedly slow the process, and this is undesirable. There is a need for a solution which can maximize introduction of laser energy into the powder material without causing molecular-weight degradation.

It is therefore an object of the present invention to improve the laser sintering process.

### SUMMARY OF THE INVENTION

This and other objects have been achieved by the present invention, the first embodiment of which includes a method for layer-by-layer production of a three dimensional object, comprising:

applying a layer of a polymer powder having a thickness;

selectively irradiating portions of the polymer powder layer with a laser beam having an average power density and a focus maximum power density to melt and sinter the irradiated polymer powder;

cooling the melted and sintered powder to obtain a solid mass having a shape; and

repeating the application, irradiating and cooling operations until the three dimensional object is obtained;

wherein a duty factor of the laser beam is greater than 60%.

In a preferred embodiment, the method includes pulse width modulation of the laser to obtain the duty factor. In a highly preferred embodiment the laser is controlled by modulating a width of pulse/on-time at constant frequency.

The present invention also provides an apparatus for the layer-by-layer production of a three dimensional object according to the embodiments described herein, the apparatus comprising at least the following components: a construction chamber; a vertically moveable construction platform in a lower surface of the construction chamber; a powder applicator; a laser; a laser control unit; and a laser beam scanner; wherein the components are arranged such that the laser beam is directed to the surface of the construction platform, and the duty factor of the laser beam is greater than 60%. In a highly preferred embodiment, the laser control unit comprises pulse width modulation.

### BRIEF DESCRIPTION OF THE DRAWINGS

FIG. 1 shows a schematic drawing of an apparatus according to one embodiment of the invention.

### DETAILED DESCRIPTION OF THE INVENTION

Surprisingly, the present inventors found that the problem described above may be solved by using a high duty factor in pulse width modulation (PWM) for the laser power control system.

Thus, the first embodiment provides a method for layer-by-layer production of a three dimensional object, comprising:

applying a layer of a polymer powder having a thickness;

selectively irradiating portions of the polymer powder layer with a laser beam having an average power density and a focus maximum power density to melt and sinter the irradiated polymer powder;

cooling the melted and sintered powder to obtain a solid mass having a shape; and

repeating the application, irradiating and cooling operations until the three dimensional object is obtained;

wherein a duty factor of the laser beam is greater than 60%.

In a preferred embodiment, the method includes pulse width modulation of the laser to obtain the duty factor. In a highly preferred embodiment the laser is controlled by modulating a width of pulse/on-time at constant frequency.

An essential, central feature of the apparatus according to the invention is the presence of a control unit which adjusts the laser to a duty factor of more than 60%, preferably more than 80% and in particular more than 90%. By using a high duty factor it may be possible to avoid or markedly reduce the molecular-weight degradation caused by the laser in the polymer, without reducing the energy input of the laser and thus the rate of the irradiation process. A particular advantage of the apparatus according to the invention is that the advantage according to the invention may be achieved merely through control of the laser, without any need for major reengineering of existing plant.

The present invention also provides an apparatus for the layer-by-layer production of a three dimensional object according to the embodiments described herein, the apparatus comprising at least the following components: a construction chamber; a vertically moveable construction platform in a lower surface of the construction chamber; a powder applicator; a laser; a laser control unit; and a laser beam scanner; wherein the components are arranged such that the laser beam is directed to the surface of the construction platform, and the duty factor of the laser beam is greater than 60%.

The control unit serves to control the laser, and it may be preferable that the laser is controlled by pulse width modulation. Pulse width modulation (PWM) is a type of modulation in which a technical variable changes between two values (on/off). The width of the pulse/on-time may be modulated at constant frequency. By using PWM, a low-loss switching operation may be achieved.

The duty factor gives the ratio of pulse duration to pulse period for a periodic sequence of pulses in accordance with DIN IEC 60469-1. The duty factor is therefore the ratio of the on-time in relation to the period. The duty factor is given as a dimensionless numeric ratio with a value from 0 to 1 or in the form of from 0 to 100%. As on-time increases in comparison with the period, the duty factor and average power also increase.

In the preferred embodiment of the apparatus according to the invention, the laser may be controlled by means of pulse width modulation, the switching frequency being at least 5 kHz, preferably at least 10 kHz and very particularly preferably at least 20 kHz.

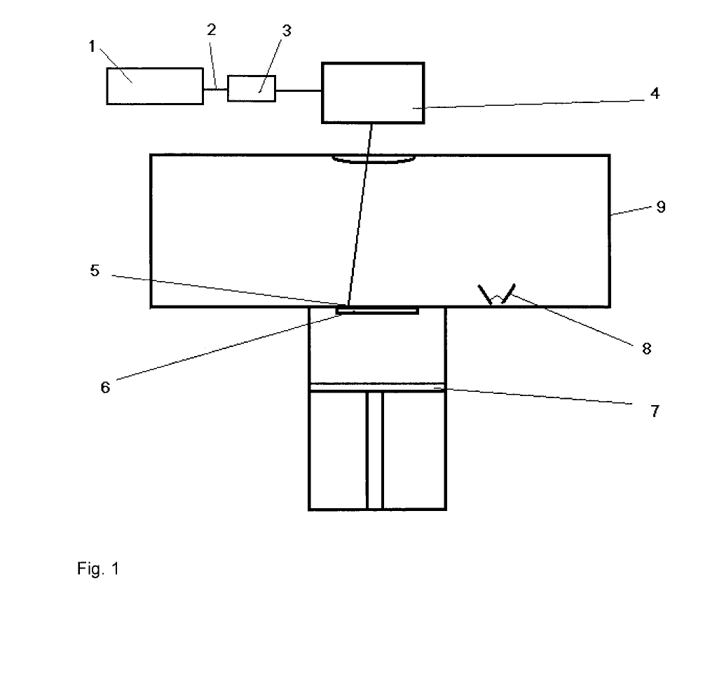

An embodiment of the apparatus according to the invention may be seen in FIG. 1, where the apparatus for the layer-by-layer production of an object comprises a construction vessel. Within the vessel, the arrangement has a plinth (6) with an upper side which is in essence level and orientated in essence parallel to the upper edge of the construction vessel. The plinth (6) has been designed to bear an object (5) to be formed. The plinth (6) can be moved vertically by a height-adjustment device (not shown). The plane within which powder material is applied and solidified is an operating plane (4).

The apparatus comprises a radiation source, e.g. in the form of a laser 1 which produces a laser beam 2. Above the construction vessel, the arrangement has a scanner (3).

The control unit (not shown) present within the apparatus according to the invention then controls the power output of the laser, in particular with the aid of PWM.

The construction vessel may optionally have temperature control and/or may be inertized with inert gas, for example with argon.

The present invention provides processes for the layer-by-layer production of three-dimensional objects from polymer powders, where the selective melting and, respectively, sintering of the polymer powder are achieved by a laser with a duty factor of more than 60%.

For the purposes of the present invention, the duty factor may be more than 60%, in particular more than 80% and particularly preferably more than 90%.

In order to avoid damage to the polymeric material during the irradiation process, the switching frequency of the laser, in particular adjusted by the control unit by means of pulse width modulation (PWM), may preferably be at least 5 kHz; at lower base frequencies the solution viscosity of the resultant components also decreases. The switching frequency may particularly preferably be more than 10 kHz, very particularly preferably more than 20 kHz.

In principle, any of the polymer powders known to the person skilled in the art are suitable for use in the apparatus according to the invention or in the process according to the invention. In particular, thermoplastic and thermoelastic materials are suitable, for example polyethylene (PE, HDPE, LDPE), polypropylene (PP), polyamides, polyesters, polyester esters, polyether esters, polyphenylene ethers, polyacetals, polyalkylene terephthalates, in particular polyethylene terephthalate (PET) and polybutylene terephthalate (PBT), polymethyl methacrylate (PMMA), polyvinyl acetal, polyvinyl chloride (PVC), polyphenylene oxide (PPO), polyoxymethylene (POM), polystyrene (PS), acrylonitrile-butadiene-styrene (ABS), polycarbonates (PC), polyether sulphones, thermoplastic polyurethanes (TPU), polyaryl ether ketones, in particular polyether ether ketone (PEEK), polyether ketone ketone (PEKK), polyether ketone (PEK), polyether ether ketone ketone (PEEKK), polyaryl ether ether ether ketone (PEEEK) or polyether ketone ether ketone ketone (PEKEKK), polyetherimides (PEI), polyarylene sulphides, in particular polyphenylene sulphide (PPS), thermoplastic polyimides (PI), polyamidimides (PAI), polyvinylidene fluorides, and also copolymers of the said thermoplastic materials, e.g. a polyaryl ether ketone (PAEK)/polyaryl ether sulphone (PAES) copolymer, mixtures and/or polymer blends. The polymer powder particularly preferably comprises at least one polyamide, in particular nylon-12.

The present invention therefore also provides a polymer powder for processing on an apparatus according to the invention for producing three-dimensional objects, where the powder comprises at least one polyamide, in particular nylon-12.

In a general method of operation, data concerning the shape of the object (5) to be produced is first generated or stored in a computer on the basis of a design program or the like. The processing of the said data for producing the object involves dissecting the object into a large number of horizontal layers which are thin in comparison with the size of the object, and providing the geometric data by way of example in the form of data sets, e.g. CAD data, for each of the said large number of layers. This data for each layer may be generated and processed prior to production or else simultaneously with production of each layer.

The construction platform (6) is then first moved by means of the height-adjustment apparatus to the highest position, in which the surface of the construction platform (6) is in the same plane as the surface of the construction chamber, and it is then lowered by an amount corresponding to the intended thickness of the first layer of material, in such a way as to form, within the resultant recess, a depressed region delimited laterally by the walls of the recess and underneath by the surface of the construction platform (6). A first layer of the material to be solidified, with the intended layer thickness, is then introduced by way of example by means of an applicator (7) into the cavity formed by the recess and by the construction platform (6), or into the depressed region, and a heating system may optionally be used to heat the layer to a suitable operating temperature, for example from 100° C. to 360° C., preferably from 120° C. to 200° C., particularly preferably from 140° C. to 160° C. These ranges include all values and subranges therein. The control unit (3) then controls the deflection device in such a way that the deflected light beam (2) successively encounters all of the positions within the layer and sinters or melts the material there. A firm initial basal layer may thus be formed. In a second step, the construction platform (6) is lowered by means of the height-adjustment apparatus by an amount corresponding to one layer thickness, and a second layer of material is introduced by means of the applicator (7) into the resultant depressed region within the recess, and the heating system is in turn optionally used to heat that layer.

In one embodiment, the deflection device may be controlled by the control unit (3) in such a way that the deflected light beam (2) encounters only that region of the layer of material that is adjacent to the internal surface of the recess, and solidifies the layer of material there by sintering, thus producing a first annular wall layer with a wall thickness of about 2 to 10 mm which completely surrounds the remaining pulverulent material of the layer. This portion of the control system therefore provides a device for producing, simultaneously with formation of the object in each layer, a vessel wall surrounding the object (5) to be formed.

After lowering the construction platform (6) by an amount corresponding to the layer thickness of the next layer, applying the material and heating in the same way as above, the production of the object (5) itself may be started. For this, the control unit (3) controls the deflection device in such a way that the deflected light beam (2) encounters those positions of the layer which are to be solidified in accordance with the coordinates stored in the control unit for the object (5) to be produced. The procedure for the remaining layers may be analogous. In cases where it is desirable to produce an annular wall region in the form of a vessel wall which encloses the object together with the remaining, unsintered material, and thus prevents escape of the material when the construction platform (6) is lowered below the base of the construction chamber, the device sinters an annular wall layer onto the annular wall layer thereunder, for each layer of the object. Production of the wall may be omitted if a replaceable vessel corresponding to EP 1037739, or a fixedly incorporated vessel, is used.

After cooling, the resultant object may be removed from the apparatus.

Any desired mouldings may be produced in a simple manner by using the apparatus according to the invention. The present invention therefore also provides mouldings produced by using an apparatus according to the invention or by using a process according to the invention. It may be particularly preferable that the solution viscosity of the mouldings produced according to the invention is at least 1.58 in accordance with ISO 307 (Schott AVS Pro, solvent acidic m-cresol, volumetric method, two measurements, dissolution temperature 100° C., dissolution time 2 h, polymer concentration 5 g/l, measurement temperature 25° C.). It is preferable that the solution viscosity of the mouldings produced according to the invention is 1.6 in accordance with ISO 307.

Having generally described this invention, a further understanding can be obtained by reference to certain specific examples which are provided herein for purposes of illustration only, and are not intended to be limiting unless otherwise specified. It is assumed that even in the absence of further details it is possible for a person skilled in the art to utilise the above description to the widest possible extent. Alternative embodiments of the present invention may be obtained analogously.

### EXAMPLES

For the purposes of the present invention, the measurement methods mentioned in Table 1 were used, and as far as technically possible these were used not only to determine the properties of the materials used but also for the resultant products.

TABLE 1

| | | | Test/Test equipment/Test |
|---|---|---|---|
| | Value | Unit | parameters |
| Bulk density | 0.445 | g/cm³ | DIN 53466 |
| d₅₀ grain size | 55 | μm | Malvern Mastersizer 2000, dry |
| | | | measurement, 20-40 g of powder |
| | | | metered into system by means of |
| | | | Scirocco dry-dispersion equipment. |
| | | | Feed rate for vibrating trough 70%, |
| | | | dispersion air pressure 3 bar. |
| | | | Sample measurement time 5 |
| | | | seconds (5000 individual |
| | | | measurements), refractive index and |
| | | | blue-light value defined as 1.52. |
| | | | Evaluation by way of Mie theory |
| d₁₀ grain size | 37 | μm | Malvern Mastersizer 2000, |
| | | | parameters, see d₅₀ grain size |
| d₉₀ grain size | 78 | μm | Malvern Mastersizer 2000, |
| | | | parameters, see d₅₀ grain size |
| <10.48 μm | 4.0 | % | Malvern Mastersizer 2000, |
| | | | parameters, see d₅₀ grain size |
| Powder- | 32 | s | DIN 53492 |
| flowability | | | |
| Solution | 1.6 | — | ISO 307, Schott AVS Pro, solvent |
| viscosity | | | acidic m-cresol, volumetric method, |
| | | | two measurements, dissolution |
| | | | temperature 100° C., dissolution time |
| | | | 2 h, polymer concentration 5 g/l, |
| | | | measurement temperature 25° C. |
| BET | 6.4 | m²/g | ISO 9277, Micromeritics TriStar |
| (spec. | | | 3000, nitrogen gas adsorption, |
| surface | | | discontinuous volumetric method, 7 |
| area) | | | measurement points at relative |
| | | | pressures P/P0 from about 0.05 to |
| | | | about 0.20, dead volume calibration |
| | | | by means of He(99.996%), sample |
| | | | preparation 1 h at 23° C. + 16 h at |
| | | | 80° C. in vacuo, spec. surface area |
| | | | based on devolatilized sample, |
| | | | evaluation occurred by means of |
| | | | multipoint determination |
| melting point, 1st | 187 | ° C. | DIN 53765 DSC 7 from Perkin |
| heating procedure | | | Elmer heating/cooling rate 20 K/min |
| Recrystallization | 138 | ° C. | DIN 53765 DSC 7 from Perkin |
| temperature | | | Elmer heating/cooling rate 20 K/min |

| | |
|---|---|
| Conditioning of | Material is stored for 24 h at 23° C. and 50% |
| material | humidity prior to processing. |

In all of the examples, a nylon-12 powder in accordance with DE19747309 which has the powder properties listed in Table 1 and which was not susceptible to post-condensation is processed in an experimental arrangement corresponding to FIG. 1. Operations for all of the examples correspond to the description below. The construction chamber is preheated to 155° C. for 180 minutes. The temperature in the construction chamber is then increased in such a way that the temperature at the powder surface is 168° C. Prior to the first irradiation, 40 layers are applied without irradiation. The component is positioned centrally in the construction area. The laser beam (2) from a laser (1) is directed by means of a scanning system (3) onto the powder surface (4), which is temperature-controlled (168° C.) and inertized (argon).

The component to be irradiated is positioned centrally within the construction area. A square area with edge length 50 mm is melted by means of the laser. The construction platform (6) is then lowered by 0.15 mm, and a fresh powder layer is applied at a rate of 100 mm/s by means of a coater (7). These steps are repeated until a three-dimensional component (5) of height 6 mm is produced. Once the irradiation has concluded, 40 more layers are also applied before the heating elements of the apparatus are switched off and the cooling phase is initiated. The time required for each layer is below 40 s during the entire construction process.

After a cooling time of at least 12 hours, the component is removed and freed from the adhering powder. A sample is taken from the core in the centre of the component, for further testing. The solution viscosity of the sample is determined in accordance with ISO 307 (test equipment: (Schott AVS Pro, solvent acidic m-cresol, volumetric method, two measurements, dissolution temperature 100° C., dissolution time 2 h, polymer concentration 5 g/l). The viscosity number thus determined provides a measure of the molecular mass of the polymer.

The experimental arrangement is designed in such a way that the focal diameter at the level of the powder surface is 0.3 mm. The laser beam focus is measured in the centre of the construction area by using a FocusMonitor from PRIMES GmbH by a method based on ISO 11146 (2nd moment method). The laser power is measured by a method based on ISO 11554 by using a LM-1000 from Coherent Deutschland GmbH, and the average power is stated here. The measurements are made in a laboratory at 23° C./50% humidity. In the examples, the laser power is controlled by means of a control device which operates by using PWM, and the power output from the laser therefore takes the form of pulses.

### Example 1 (Not According to the Invention)

A Synrad Firestar t100W serves as laser (CO₂, wavelength 10.6 μm). A UC-2000 from Synrad was used to control the power of the laser. A DC-100 DC from Synrad is used as power supply unit. A Scanlab powerSCAN 50 scanner combined with varioSCAN 60 is used. The pulse width modulation (PWM) switching frequency selected is 5 kHz with a duty factor of 20%. Laser energy input is 60 mJ/mm² (laser power 21.2 W, scan rate 1178 mm/s, separation of irradiation lines 0.3 mm). The solution viscosity determined on the component sample is 1.52 in accordance with ISO 307.

### Example 2 (Not According to the Invention)

A ULR-50 from Universal Laser Systems Inc. serves as laser (CO₂, wavelength 10.6 μm). An LCT 3001 Laser-Multi Controller from MCA Micro Controller Applications is used to control the power of the laser. The power supply unit is the Synrad DC-5. A Scanlab powerSCAN 50 scanner with varioSCAN 60 is used. The pulse width modulation (PWM) switching frequency is 5 kHz with a duty factor of 40%. Laser energy input is 60 mJ/mm² (laser power 20.6 W, scan rate of laser beam 1144 mm/s, separation of irradiation lines 0.3 mm). The solution viscosity determined on the component sample is 1.55 in accordance with ISO 307.

### Example 3 (Not According to the Invention)

A ULR-50 from Universal Laser Systems Inc. serves as laser (CO₂, wavelength 10.6 μm). An LCT 3001 Laser-Multi Controller from MCA Micro Controller Applications is used to control the power of the laser. The power supply unit is the Synrad DC-5. A Scanlab powerSCAN 50 scanner with varioSCAN 60 is used. The pulse width modulation (PWM) switching frequency is 1 kHz with a duty factor of 40%. Laser energy input is 60 mJ/mm² (laser power 20.6 W, scan rate 1144 mm/s, separation of irradiation lines 0.3 mm). The solution viscosity determined on the component sample is 1.52 in accordance with ISO 307.

### Example 4 (Not According to the Invention)

An OTF150-30-0.2 diode laser (wavelength 980 nm) from Optotools is used. An LCT 3001 Laser-Multi Controller from MCA Micro Controller Applications is used to control the power of the laser. A DL 1600 power supply unit from Heim Electronic, and the Raylase SS-20 scanner, are used. The pulse width modulation (PWM) switching frequency is 5 kHz with a duty factor of 40%. 0.1% of Printex alpha is admixed with the PA 12 powder to improve laser energy absorption. Laser energy input is 60 mJ/mm² (laser power 52.6 W, scan rate 2922 mm/s, separation of irradiation lines 0.3 mm). The solution viscosity determined on the component sample is 1.54 in accordance with ISO 307.

### Example 5 (Not According to the Invention)

An IPG-ELR-100-1550 fibre laser (wavelength 1550) is used. An LCT 3001 Laser-Multi Controller from MCA Micro Controller Applications is used to control the power of the laser. A DL 1600 power supply unit from Heim Electronic, and the Raylase SS-10 scanner, are also used. The pulse width modulation (PWM) switching frequency is 5 kHz with a duty factor of 40%. 0.1% of Printex alpha is admixed with the PA 12 powder to improve laser energy absorption. Laser energy input is 60 mJ/mm² (laser power 42.1 W, scan rate 2338 mm/s, separation of irradiation lines 0.3 mm). The solution viscosity determined on the component sample is 1.55 in accordance with ISO 307.

### Example 6 (According to the Invention)

A ULR-50 from Universal Laser Systems Inc. serves as laser (CO₂, wavelength 10.6 μm). An LCT 3001 Laser-Multi Controller from MCA Micro Controller Applications is used to control the power of the laser. A Synrad DC-5 power supply unit is used. A Scanlab powerSCAN 50 scanner with varioSCAN 60 is used. The pulse width modulation (PWM) switching frequency is 5 kHz with a duty factor of 60%. Laser energy input is 60 mJ/mm² (laser power 29.2 W, scan rate 1622 mm/s, separation of irradiation lines 0.3 mm). The solution viscosity determined on the component sample is 1.58 in accordance with ISO 307.

### Example 7 (According to the Invention)

A ULR-50 from Universal Laser Systems Inc. serves as laser (CO₂, wavelength 10.6 μm). An LCT 3001 Laser-Multi Controller from MCA Micro Controller Applications is used to control the power of the laser. A Synrad DC-5 power supply unit is used. A Scanlab powerSCAN 50 scanner with varioSCAN 60 is used. The pulse width modulation (PWM) switching frequency is 10 kHz with a duty factor of 60%. Laser energy input is 60 mJ/mm² (laser power 29.2 W, scan rate 1622 mm/s, separation of irradiation lines 0.3 mm). The solution viscosity determined on the component sample is 1.6 in accordance with ISO 307.

### Example 8 (According to the Invention)

A ULR-50 from Universal Laser Systems Inc. serves as laser (CO₂, wavelength 10.6 μm). An LCT 3001 Laser-Multi Controller from MCA Micro Controller Applications is used to control the power of the laser. A Synrad DC-5 power supply unit is used. A Scanlab powerSCAN 50 scanner with varioSCAN 60 is used. The pulse width modulation (PWM) switching frequency is 20 kHz with a duty factor of 60%. Laser energy input is 60 mJ/mm² (laser power 29.2 W, scan rate 1622 mm/s, separation of irradiation lines 0.3 mm). The solution viscosity determined on the component sample is 1.6 in accordance with ISO 307.

### Example 9 (According to the Invention)

Synrad 48-2 serves as laser (CO₂, wavelength 10.6 μm). A UC-2000 controller from Synrad is used to control the power of the laser. A DC-2 power supply unit from Synrad is used. A Scanlab powerSCAN 50 scanner with varioSCAN 60 is used. The pulse width modulation (PWM) switching frequency is 5 kHz with a duty factor of 80%. Laser energy input is 60 mJ/mm² (laser power 18.9 W, scan rate 1050 mm/s, separation of irradiation lines 0.3 mm). The solution viscosity determined on the component sample is 1.6 in accordance with ISO 307.

### Example 10 (According to the Invention)

Synrad 48-2 serves as laser (CO₂, wavelength 10.6 μm). A UC-2000 controller from Synrad is used to control the power of the laser. A DC-2 power supply unit from Synrad is used. A Scanlab powerSCAN 50 scanner with varioSCAN 60 is used. The pulse width modulation (PWM) switching frequency is 5 kHz with a duty factor of 90%. Laser energy input was 60 mJ/mm² (laser power 19.8 W, scan rate 1110 mm/s, separation of irradiation lines 0.3 mm). The solution viscosity determined on the component sample is 1.6 in accordance with ISO 307.

### Example 11 (According to the Invention)

An IPG-ELR-100-1550 fibre laser (wavelength 1550 nm) is used in combination with a Raylase SS-10 scanner and an LCT 3001 Laser-Multi Controller from MCA Micro Controller Applications to control the power of the laser, and a DL 1600 power supply unit from Heim Electronic. The pulse width modulation (PWM) switching frequency is 5 kHz with a duty factor of 60%. 0.1% of Printex alpha is admixed with the PA 12 powder to improve laser energy absorption. Laser energy input is 60 mJ/mm² (laser power 60.5 W, scan rate 3360 mm/s, separation of irradiation lines 0.3 mm). The solution viscosity determined on the component sample is 1.59 in accordance with ISO 307.

### Example 12 (According to the Invention)

An OTF150-30-0.2 diode laser (wavelength 980 nm) from Optotools is used in combination with a Raylase SS-20 scanner and with an LCT 3001 Laser-Multi Controller from MCA Micro Controller Applications to control the power of the laser, and a DL 1600 power supply unit from Heim Electronic. The pulse width modulation (PWM) switching frequency is 5 kHz with a duty factor of 60%. 0.1% of Printex alpha is admixed with the PA 12 powder to improve laser energy absorption. Laser energy input is 60 mJ/mm² (laser power 77.9 W, scan rate 4328 mm/s, separation of irradiation lines 0.3 mm). The solution viscosity determined on the component sample is 1.59 in accordance with ISO 307.

Table 2 collates the results. The solution viscosity of the cooled melt of the examples not according to the invention decreases markedly at duty factors of less than 60%. Reduced solution viscosity indicates molecular-weight degradation caused by local temperature peaks. Molecular-weight degradation may in turn have a markedly adverse effect on the properties of components which are produced by means of laser sintering.

In order to avoid damage to the polymeric material during the irradiation process, the pulse width modulation (PWM) switching frequency should moreover be at least 5 kHz. At lower base frequencies the solution viscosity of the resultant components also decreases, as may be discerned from a comparison of examples 2 and 3 not according to the invention.

TABLE 2

| | | Switching frequency | |
|---|---|---|---|
| | Duty factor [%] | [kHz] | Solution viscosity |
| Example 1 | 20 | 5 | 1.52 |
| Example 2 | 40 | 5 | 1.55 |
| Example 3 | 40 | 1 | 1.52 |
| Example 4 | 40 | 5 | 1.54 |
| Example 5 | 40 | 5 | 1.55 |
| Example 6 | 60 | 5 | 1.58 |
| Example 7 | 60 | 10 | 1.6 |
| Example 8 | 60 | 20 | 1.6 |
| Example 9 | 80 | 5 | 1.6 |
| Example 10 | 90 | 5 | 1.6 |
| Example 11 | 60 | 5 | 1.59 |
| Example 12 | 60 | 5 | 1.59 |

1. A method for layer-by-layer production of a three dimensional object, comprising:
applying a layer of a polymer powder having a thickness;
selectively irradiating portions of the polymer powder layer with a laser beam having an average power density and a focus maximum power density to melt and sinter the irradiated polymer powder;
cooling the melted and sintered powder to obtain a solid mass having a shape; and
repeating the application, irradiating and cooling operations until the three dimensional object is obtained;
wherein a duty factor of the laser beam is greater than 60%.

2. The method according to claim 1, further comprising heating the polymer powder layer prior to the laser irradiation.

3. The method according to claim 1, further comprising pulse width modulation of the laser to obtain the duty factor.

4. The method according to claim 1, further comprising controlling the laser by modulating a width of pulse/on-time at constant frequency.

5. The method according to claim 1 wherein the switching frequency of the laser is at least 5 kHz.

6. The method according to claim 1, wherein the polymer powder comprises a polymer selected from the group consisting of polyethylene (PE, HDPE, LDPE), polypropylene (PP), polyamides, polyesters, polyester esters, polyether esters, polyphenylene ethers, polyacetals, polyalkylene terephthalates, polymethyl methacrylate (PMMA), polyvinyl acetal, polyvinyl chloride (PVC), polyphenylene oxide (PPO), polyoxymethylene (POM), polystyrene (PS), acrylonitrile-butadiene-styrene (ABS), polycarbonates (PC), polyether sulphones, thermoplastic polyurethanes (TPU), polyaryl ether ketones, polyetherimides (PEI) and polyarylene sulphides.

7. The method according to claim 6, wherein the polymer powder comprises a polyamide.

8. The method according to claim 7, wherein the polyamide is nylon-12, having a solution viscosity of 1.6, in accordance with ISO 307.

9. The method according to claim 8, further comprising adding a radiation absorber to the nylon 12.

10. The method according to claim 1, further comprising inertizing the polymer powder during the application, irradiating and cooling operations.

11. The method according to claim 10, wherein the inertizing comprises placing the polymer powder under argon.

12. The method according to claim 1, further comprising irradiation of the polymer powder to form a walls of a container about the three dimensional object.

13. The method according to claim 8, wherein a solution viscosity of the melted and sintered polymer is at least 1.58, according to ISO 307.

14. A three dimensional object obtained by the method according to claim 1.

15. A three dimensional object obtained by the method according to claim 13.

16. An apparatus for the layer-by-layer production of a three dimensional object according to claim 1, the apparatus comprising at least the following components:
a construction chamber;
a vertically moveable construction platform in a lower surface of the construction chamber;
a powder applicator;
a laser;
a laser control unit; and
a laser beam scanner;
wherein the components are arranged such that the laser beam is directed to the surface of the construction platform, and
the duty factor of the laser beam is greater than 60%.

17. The apparatus according to claim 16, wherein the laser control unit comprises pulse width modulation.

18. The apparatus according to claim 16, further comprising a heating system to heat a powder on the construction platform.

19. The apparatus according to claim 16, further comprising a height adjustment apparatus on the construction platform.

20. The apparatus according to claim 16, wherein the construction chamber is inertized.
